(19) United States
(12) Patent Application Publication
(10) Pub. No.: US 2006/0191632 A1
(43) Pub. Date: Aug. 31, 2006

(54) Method for producing flexible metal foil-polyimide laminate

(75) Inventors: Masahiro Usuki, Ibaraki (JP); Michio Aizawa, Ibaraki (JP); Shigehiro Hoshida, Ibaraki (JP); Tadashi Amano, Ibaraki (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Shin-Etsu Chemical Co., Ltd., Tokyo (JP)

(21) Appl. No.: 10/545,810

(22) PCT Filed: Jun. 16, 2004
(86) PCT No.: PCT/JP04/08788

§ 371 Date: Aug. 16, 2005

(30) Foreign Application Priority Data
Jun. 25, 2003 (JP) 2003-181236

(51) Int. Cl. B32B 37/00

(52) U.S. Cl. 156/331.1; 156/307.7

(57) ABSTRACT

A method for preparing a flexible metal foil/polyimide laminate is characterized by laminating a metal foil and a polyimide film, with a heat resistant adhesive interleaved therebetween, on a heating roll press, and heat treating the laminate for removing the residual solvent from the adhesive layer and heat curing the adhesive layer.

### TECHNICAL FIELD

This invention relates to a method for preparing flexible metal foil/polyimide laminates which are used in electronic parts such as printed boards.

### BACKGROUND ART

It is known in the art to manufacture flexible substrates by applying a polyimide precursor resin solution directly onto a conductor, followed by drying and curing, as disclosed, for example, in JP-A 59-232455, JP-A 61-275325, JP-A 62-212140, and JP-A 7-57540. Another method of applying a polyimide precursor resin solution in several divided portions onto a conductor is disclosed, for example, in JP-A 2-180682, JP-A 2-180679, JP-A 1-245586 and JP-A 2-122697.

However, the method of applying a polyimide precursor resin solution onto a conductor has the problem that unless the ultimate polyimide layer on the flexible substrate has a thickness of at least 20 microns, the substrate is awkward to handle because of the lack of so-called “body.” This inevitably necessitates that the polyimide precursor resin be so thickly applied and cured to a conductor as to form an ultimate polyimide layer of at least 20 microns thick. Since it is thus difficult to apply to a uniform thickness, thickness variations frequently occur, resulting in faulty products. This indicates the tendency that when the solution is applied in several divided portions, thickness variations become exaggerated with an increasing number of divided portions.

It was then proposed to form a thermoplastic polyimide layer on a conductor before lamination as disclosed, for example, in JP-A 1-244841 and JP-A 6-190967. With this method, the thermoplastic polyimide layer is pressure bonded so that the thickness of the entire polyimide layer becomes uniform. In particular, in the process of applying a polyimide or polyamide acid solution, drying and curing to form a thermoplastic polyimide/metal foil laminate, and bonding a polyimide film to the thermoplastic polyimide side under heat and pressure, as taught in JP-A 6-190967, the thermoplastic polyimide is melted by heating so that the thickness is corrected. As a result, the entire polyimide layer after laminated with the polyimide film has a uniform thickness.

Nevertheless, this process is not economical because the once cured polyimide must be bonded under heat and pressure, which requires a special equipment capable of heating to a temperature above the glass transition temperature (Tg) of polyimide.

### DISCLOSURE OF THE INVENTION

An object of the present invention is to provide a method for preparing flexible metal foil/polyimide laminates, which takes full advantage of the properties of heat resistant polyimide resin film including excellent heat resistance, chemical resistance, flame retardance and electrical properties.

Making extensive investigations to attain the above object, the inventor has found that by laminating a metal foil and a polyimide film via a heat resistant adhesive, preferably a polyamic acid having an imidization degree of less than 5%, more preferably a solvent content of 3 to 50% by weight, and heat treating the laminate for removing the solvent from the adhesive and heat curing the adhesive, a flexible metal foil/polyimide laminate having increased bond strength can be prepared at a low drying temperature and a low laminating temperature.

Accordingly, the present invention provides a method for preparing a flexible metal foil/polyimide laminate, as set forth below.

[1] A method for preparing a flexible metal foil/polyimide laminate, characterized by laminating a metal foil and a polyimide film, with a heat resistant adhesive interleaved therebetween, on a heating roll press, and then heat treating the laminate for removing the residual solvent from the adhesive layer and heat curing the adhesive layer.

[2] The above method for preparing a flexible metal foil/polyimide laminate, wherein in the laminating step, the heat resistant adhesive comprises a polyamic acid having an imidization degree of less than 5%.

[3] The above method for preparing a flexible metal foil/polyimide laminate, wherein in the laminating step, the heat resistant adhesive comprises a polyamic acid having a solvent content of 3 to 50% by weight.

[4] The above method for preparing a flexible metal foil/polyimide laminate, wherein in the laminating step, the heat resistant adhesive having a solvent content of 3 to 50% by weight has a softening point of up to 150° C.

[5] The above method for preparing a flexible metal foil/polyimide laminate, wherein an adhesive component is a polyamic acid selected from the group consisting of a condensate of pyromellitic anhydride with 4,4′-diaminodiphenyl ether, a condensate of 3,4,3′,4′-biphenyltetracarboxylic anhydride with p-phenylenediamine, and mixtures thereof.

[6] The above method for preparing a flexible metal foil/polyimide laminate, wherein the metal foil is a rolled copper foil having a thickness of at least 10 μm, the polyimide film has a thickness of at least 12 μm, and the heat resistant adhesive layer has a thickness of up to 5 μm.

[7] The above method for preparing a flexible metal foil/polyimide laminate, wherein the flexible metal foil/polyimide laminate is a flexible single side metal foil/polyimide laminate or a flexible double side metal foil/polyimide laminate.

### BEST MODE FOR CARRYING OUT THE INVENTION

The polyimide film used in the preparation of flexible metal foil/polyimide laminates according to the invention may be any of polyimide films that are conventionally used in laminates of this type. There may be used films of polyimide resins of the general formula (III) which are obtained from diamine compounds of the general formula (I) and tetracarboxylic acid dianhydrides of the general formula (II), shown below. Commercial products may also be used. Examples of commercial products that can be used herein include

Apical (trade name) by Kaneka Corp. and

Kapton (trade name) by Dupont-Toray Co., Ltd.
H₂N—R₁—NH₂ (I)
Herein R₁ is a divalent radical selected from the group consisting of an aliphatic radical, cycloaliphatic radical, monocyclic aromatic radical, fused polycyclic aromatic radical and non-fused cyclic aromatic radical having aromatics joined directly or via a linking member. 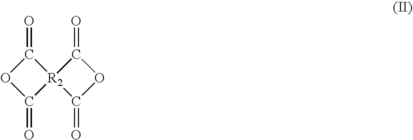
Herein R₂ is a tetravalent radical selected from the group consisting of an aliphatic radical, cycloaliphatic radical, monocyclic aromatic radical, fused polycyclic aromatic radical and non-fused cyclic aromatic radical having aromatics joined directly or via a linking member. 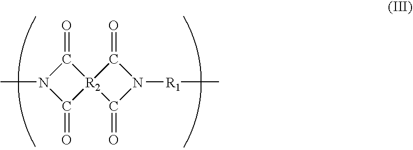
Herein R₁ and R₂ are as defined above.

Examples of the diamine of general formula (I) include o-phenylenediamine, m-phenylenediamine, p-phenylenediamine, m-aminobenzylamine, p-aminobenzylamine, 2-chloro-1,2-phenylenediamine, 4-chloro-1,2-phenylenediamine, 2,3-diaminotoluene, 2,4-diaminotoluene, 2,5-diaminotoluene, 2,6-diaminotoluene, 3,4-diaminotoluene, 2-methoxy-1,4-phenylenediamine, 4-methoxy-1,3-phenylenediamine, benzidine, 3,3′-dichlorobenzidine, 3,3′-dimethylbenzidine, 3,3′-dimethoxybenzidine, 3,3′-diaminodiphenyl ether, 3,4′-diaminodiphenyl ether, 4,4′-diaminodiphenyl ether, 3,3′-diaminodiphenyl sulfide, 3,4′-diaminodiphenyl sulfide, 4,4′-diaminodiphenyl sulfide, 3,3′-diaminodiphenyl sulfoxide, 4,4′-diaminodiphenyl sulfoxide, 3,3′-diaminodiphenyl sulfone, 3,4′-diaminodiphenyl sulfone, 4,4′-diaminodiphenyl sulfone, 3,3′-diaminobenzophenone, 3,4′-diaminobenzophenone, 4,4′-diaminobenzophenone, 3,3′-diaminodiphenylmethane, 3,4′-diaminodiphenylmethane, 4,4′-diaminodiphenylmethane, bis[4-(3-aminophenoxy)phenyl]methane, bis[4-(4-aminophenoxy)phenyl]methane, 1,1-bis[4-(3-aminophenoxy)phenyl]ethane, 1,1-bis[4-(4-aminophenoxy)phenyl]ethane, 1,2-bis[4-(3-aminophenoxy)phenyl]ethane, 1,2-bis[4-(4-aminophenoxy)phenyl]ethane, 2,2-bis[4-(3-aminophenoxy)phenyl]propane, 2,2-bis[4-(4-aminophenoxy)phenyl]propane, 2,2-bis[4-(3-aminophenoxy)phenyl]butane, 2,2-bis[4-(4-aminophenoxy)phenyl]butane, 2,2-bis[4-(3-aminophenoxy)phenyl]-1,1,1,3,3,3-hexafluoro-propane, 2,2-bis[4-(4-aminophenoxy)phenyl]-1,1,1,3,3,3-hexafluoro-propane, 1,3-bis(3-aminophenoxy)benzene, 1,3-bis(4-aminophenoxy)benzene, 1,4-bis(3-aminophenoxy)benzene, 1,4-bis(4-aminophenoxy)benzene, 4,4′-bis(3-aminophenoxy)biphenyl, 4,4′-bis(4-aminophenoxy)biphenyl, bis[4-(3-aminophenoxy)phenyl]ketone, bis[4-(4-aminophenoxy)phenyl]ketone, bis[4-(3-aminophenoxy)phenyl]sulfide, bis[4-(4-aminophenoxy)phenyl]sulfide, bis[4-(3-aminophenoxy)phenyl]sulfoxide, bis[4-(4-aminophenoxy)phenyl]sulfoxide, bis[4-(3-aminophenoxy)phenyl]sulfone, bis[4-(4-aminophenoxy)phenyl]sulfone, bis[4-(3-aminophenoxy)phenyl]ether, bis[4-(4-aminophenoxy)phenyl]ether, 1,4-bis[4-(3-aminophenoxy)benzoyl]benzene, 1,3-bis[4-(3-aminophenoxy)benzoyl]benzene, 4,4-bis[3-(4-aminophenoxy)benzoyl]diphenyl ether, 4,4-bis[3-(3-aminophenoxy)benzoyl]diphenyl ether, 4,4-bis[4-(4-amino-α,α-dimethylbenzyl)phenoxy]benzophenone, 4,4-bis[4-(4-amino-α,α-dimethylbenzyl)phenoxy]diphenyl sulfone, bis[4-([4-(4-aminophenoxy)phenoxy]phenyl]ketone, bis[4-([4-(4-aminophenoxy)phenoxy]phenyl]sulfone, 1,4-bis[4-(4-aminophenoxy)-α,α-dimethylbenzyl]benzene, and 1,3-bis[4-(4-aminophenoxy)-α,α-dimethylbenzyl]benzene, which may be used alone or in admixture of any.

The tetracarboxylic acid dianhydrides of the general formula (II) include

those of formula (II) wherein R₂ is an aliphatic radical, such as ethylenetetracarboxylic dianhydride;

those of formula (II) wherein R₂ is a cycloaliphatic radical, such as cyclopentanetetracarboxylic dianhydride;

those of formula (II) wherein R₂ is a monocyclic aromatic radical, such as 1,2,3,4-benzenetetracarboxylic dianhydride and pyromellitic dianhydride;

those of formula (II) wherein R₂ is a fused polycyclic aromatic radical, such as 2,3,6,7-naphthalenetetracarboxylic dianhydride, 1,4,5,8-naphthalenetetracarboxylic dianhydride, 1,2,5,6-naphthalenetetracarboxylic dianhydride, 3,4,9,10-perillenetetracarboxylic dianhydride, 2,3,6,7-anthracenetetracarboxylic dianhydride, and 1,2,7,8-phenanthrenetetracarboxylic dianhydride;

those of formula (II) wherein R₂ is a non-fused cyclic aromatic radical having aromatics joined directly, such as 3,3′,4,4′-biphenyltetracarboxylic dianhydride and 2,2′,3,3′-biphenyltetracarboxylic dianhydride; and

those of formula (II) wherein R₂ is a non-fused cyclic aromatic radical having aromatics joined via a linking member, such as 3,3′,4,4′-benzophenonetetracarboxylic dianhydride, 2,2′,3,3′-benzophenonetetracarboxylic dianhydride, 2,2-bis(3,4-dicarboxyphenyl)propane dianhydride, 2,2-bis(2,3-dicarboxyphenyl)propane dianhydride, bis(3,4-dicarboxyphenyl)ether dianhydride, bis(3,4-dicarboxyphenyl)sulfone dianhydride, bis(2,3-dicarboxyphenyl)sulfone dianhydride, 1,1-bis(2,3-dicarboxyphenyl)ethane dianhydride, bis(2,3-dicarboxyphenyl)methane dianhydride, bis(3,4-dicarboxyphenyl)methane dianhydride, 4,4′-(p-phenylenedioxy)diphthalic dianhydride and 4,4′-(m-phenylenedioxy)diphthalic dianhydride, which may be used alone or in admixture of any.

The thickness of the polyimide film is not particularly limited and may be suitably selected although it is generally in a range of 12 to 75 μm, preferably 12 to 25 μm.

On the other hand, the type of the metal foil used herein is not critical. Often, copper, nickel, aluminum, stainless steel and beryllium-copper alloys are used. Copper foil is most often used as the metal foil for forming printed circuits. The copper foil used herein may be either rolled copper foil or electrolytic copper foil. To enhance the bond strength between a metal foil and a polyimide film in direct contact therewith, a layer of inorganic matter, typically elemental metal or an oxide or alloy thereof may be formed on the metal foil. In the case of a copper foil, for example, a layer of elemental copper, copper oxide, nickel-copper alloy or zinc-copper alloy may be formed on the metal foil. Alternatively, instead of the inorganic matter, coupling agents such as aminosilanes, epoxysilanes and mercaptosilanes may be coated onto the metal foil.

The thickness of the metal foil is not particularly limited and may be suitably selected although it is generally in a range of 10 to 35 μm, preferably 18 to 35 μm.

In the practice of the invention, the metal foil and the polyimide film are laminated together by means of a heating roll press while a heat resistant adhesive is interleaved therebetween.

The heat resistant adhesive used herein is preferably a polyamic acid. The polyamic acid used herein as the adhesive is obtained by reacting an aromatic tetracarboxylic acid anhydride with an aromatic diamine.

The acid anhydrides used herein include tetracarboxylic acid anhydrides and derivatives thereof. It is noted that although examples of tetracarboxylic acid are described below, esters, anhydrides and chlorides of such acids can, of course, be employed. Illustrative examples of suitable tetracarboxylic acid include pyromellitic acid, 3,3′,4,4′-biphenyltetracarboxylic acid, 3,3′,4,4′-benzophenonetetracarboxylic acid, 3,3′,4,4′-diphenylsulfonetetracarboxylic acid, 3,3′,4,4′-diphenylethertetracarboxylic acid, 2,3,3′,4′-benzophenonetetracarboxylic acid, 2,3,6,7-naphthalenetetracarboxylic acid, 1,2,5,6-naphthalenetetracarboxylic acid, 3,3′,4,4′-diphenylmethanetetracarboxylic acid, 2,2-bis(3,4-dicarboxyphenyl)propane, 2,2-bis(3,4-dicarboxyphenyl)hexafluoropropane, 3,4,9,10-tetracarboxyperillene, 2,2-bis[4-(3,4-dicarboxyphenoxy)phenyl]propane, 2,2-bis[4-(3,4-dicarboxyphenoxy)phenyl]hexafluoropropane, butanetetracarboxylic acid, and cyclopentanetetracarboxylic acid. Also included are trimellitic acid and derivatives thereof.

It is also possible to introduce a crosslinked structure or ladder structure through modification with a compound having a reactive functional group.

Examples of the diamine used herein include p-phenylenediamine, m-phenylenediamine, 2′-methoxy-4,4′-diaminobenzanilide, 4,4′-diaminodiphenyl ether, diaminotoluene, 4,4′-diaminodiphenylmethane, 3,3′-dimethyl-4,4′-diaminodiphenylmethane, 3,3′-diethyl-4,4′-diaminodiphenylmethane, 2,2-bis[4-(4-aminophenoxy)phenyl]propane, 1,2-bis(anilino)ethane, diaminodiphenyl sulfone, diaminobenzanilide, diaminobenzoate, diaminodiphenyl sulfide, 2,2-bis(p-aminophenyl)propane, 2,2-bis(p-aminophenyl)hexafluoropropane, 1,5-diaminonaphthalene, diaminotoluene, diaminobenzotrifluoride, 1,4-bis(p-aminophenoxy)benzene, 4,4′-(p-aminophenoxy)biphenyl, diaminoanthraquinone, 4,4′-bis(3-aminophenoxyphenyl)diphenyl sulfone, 1,3-bis(anilino)hexafluoropropane, 1,4-bis(anilino)octafluoropropane, 1,5-bis(anilino)decafluoropropane, 1,7-bis(anilino)tetradecafluoropropane, 2,2-bis[4-(p-aminophenoxy)phenyl]hexafluoropropane, 2,2-bis[4-(3-aminophenoxy)phenyl]hexafluoropropane, 2,2-bis[4-(2-aminophenoxy)phenyl]hexafluoropropane, 2,2-bis[4-(4-aimonophenoxy)-3,5-dimethylphenyl]hexafluoro-propane, 2,2-bis[4-(4-aimonophenoxy)-3,5-ditrifluoromethylphenyl]-hexafluoropropane, p-bis(4-amino-2-trifluoromethylphenoxy)benzene, 4,4′-bis(4-amino-2-trifluoromethylphenoxy)biphenyl, 4,4′-bis(4-amino-3-trifluoromethylphenoxy)biphenyl, 4,4′-bis(4-amino-2-trifluoromethylphenoxy)diphenyl sulfone, 4,4′-bis(4-amino-5-trifluoromethylphenoxy)diphenyl sulfone, 2,2-bis[4-(4-amino-3-trifluoromethylphenoxy)phenyl]hexa-fluoropropane, benzidine, 3,3′,5,5′-tetramethylbenzidine, octafluorobenzidine, 3,3′-methoxybenzidine, o-tolidine, m-tolidine, 2,2′,5,5′,6,6′-hexafluorotolidine, 4,4″-diaminoterphenyl, and 4,4″′-diaminoquarterphenyl. Also included are diisocyanates obtained through reaction of the foregoing diamines with phosgene or the like, and diaminosiloxanes.

Examples of the solvent used herein include N-methylpyrrolidone (NMP), dimethylformamide (DMF), dimethylacetamide (DMAc), dimethyl sulfoxide (DMSO), dimethyl sulfate, sulfolane, butyrolactone, cresol, phenol, halogenated phenols, cyclohexanone, dioxane, tetrahydrofuran and diglyme.

It is noted that the polyimide film is generally formed of a condensate of pyromellitic anhydride with 4,4′-diaminodiphenyl ether, or a condensate of 3,4,3′,4′-biphenyltetracarboxylic anhydride with p-phenylenediamine. Making extensive investigations on the use as an adhesive of a polyamic acid which when heat cured, forms a polyimide adhesive layer possessing the same chemical structure as and equivalent properties to the polyimide film used in the laminate, the inventors have found that a polyamic acid selected from the group consisting of a condensate of pyromellitic anhydride with 4,4′-diaminodiphenyl ether, a condensate of 3,4,3′,4′-biphenyltetracarboxylic anhydride with p-phenylenediamine, and mixtures thereof is especially preferred as the adhesive; and that the condensation reaction is preferably effected in a polar solvent such as DMAc or NMP alone or in admixture at a reaction temperature of 10 to 40° C., a reaction solution concentration of up to 30% by weight, a molar ratio of aromatic tetracarboxylic anhydride/aromatic diamine between 0.95:1.00 and 1.05:1.00, and a N₂ atmosphere. It is understood that the methods of dissolving and adding the reactants are not particularly limited.

In the practice of the invention, it is also possible to copolymerize the above condensates and the like or use a blend of polyamic acids. Also inorganic, organic or metallic substances in powder or fiber form may be used in combination for the purpose of improving some properties. There can further be added additives such as antioxidants for the purpose of preventing conductors from oxidation or silane coupling agents for the purpose of improving adhesion. It is further possible to blend different polymers for the purpose of improving adhesion or the like.

In the inventive method for preparing flexible metal foil/polyimide laminates, the polyamic acid is cast onto a metal foil such as copper foil so as to give a coating thickness of up to 5 μm, more preferably 2 to 5 μm, even more preferably 2 to 4 μm after imidization, and dried at a temperature at which little or no imidization proceeds (preferably an imidization degree of less than 5%) until a solvent content of 3 to 50% by weight is reached. Thereafter, the metal foil is laminated with a polyimide film on a heating roll press, preferably followed by solvent drying and imidization. This sequence of steps is effective for manufacturing a curl-free, all polyimide flexible metal foil laminate without detracting from the properties such as heat resistance of the adhesive which have been problematic in the prior art.

The adhesive used in the preparing method of the invention is substantially referred to as a polyamic acid having an imidization degree of less than 5%, more preferably less than 3%, even more preferably less than 1%, at the stage of lamination, and having a softening point of up to 150° C., more preferably 80 to 150° C., even more preferably 80 to 120° C. on account of the inclusion of the solvent. The polyamic acid is obtained by reacting an aromatic diamine with an aromatic tetracarboxylic acid anhydride in a polar solvent, and the reaction solution can be used in the adhesive as varnish without further treatment.

The polyamic acid used herein is obtained through condensation reaction of an aromatic tetracarboxylic acid anhydride with an aromatic diamine and as described above, it is preferably selected from the group consisting of a condensate of pyromellitic anhydride with 4,4′-diaminodiphenyl ether, a condensate of 3,4,3′,4′-biphenyltetracarboxylic anhydride with p-phenylenediamine, and mixtures thereof. In this context, the metal foil used in the laminate is preferably a rolled copper foil of at least 10 μm, more preferably 10 to 35 μm, even more preferably 18 to 35 μm thick, and the polyimide film is preferably of Kapton type with a thickness of at least 12 μm. more preferably 12 to 75 μm, even more preferably 12 to 25 μm. With respect to the coating buildup of the polyamic acid, the varnish is preferably coated such that the thickness after imidization is up to 5 μm. If the rolled copper foil has a thickness of less than 10 μm, there may arise problems including creases during its manufacture and strength in the laminating step which sometimes calls for the use of a protective member.

Although the polyimide film used is preferably of Kapton or Upilex type with a thickness of at least 12 μm as described above, the polyimide film on the surface may be subjected to plasma or etching treatment.

It is noted that the laminate can have a substantial amount of curl if the adhesive layer has a thickness of more than 5 μm.

In the practice of the invention, preferably the polyamic acid varnish is coated to a work surface of a metal foil such as a rolled copper foil and dried, while the apparatus and technique used therefor are not particularly limited. For coating, use may be made of a comma coater, T-die, roll coater, knife coater, reverse coater, lip coater or the like. Drying is suitably done at a temperature of up to 120° C. that induces bonding, preferably 80 to 120° C. such that at the time of passage through the heating roll press, the solvent content is 3 to 50% by weight, preferably 3 to 10% by weight and the varnish remains as polyamic acid having undergone no substantial imidization (imidization degree less than 5%).

If the solvent content is more than 50% by weight, it may cause bubbles or blisters at the time of roll pressing or post-curing. When thermal history is continued until the solvent content is below 3% by weight, partial imidization begins and the polyamic acid layer has a softening point in excess of 150° C. This requires a high temperature and a high pressure during lamination on the heating roll press, resulting in an increased cost of facility.

The means of heating the roll press includes heating of the rolls directly with oil or steam. With respect to the roll material, metal rolls such as carbon steel, and rubber rolls of heat resistant fluorine rubber or silicone rubber may be used.

Roll press conditions are not particularly limited. Preferably pressing is done at a temperature in the range of from the softening point of solvent-containing polyamic acid after drying to the boiling point of the solvent used, typically 100 to 150° C. and a linear pressure in the range of 5 to 100 kg/cm.

With respect to the solvent drying and imidization steps after the laminating step, the solvent drying temperature may be equal to or below the boiling point of the solvent used in the varnish, typically 30 to 200° C., preferably 40 to 150° C., and the solvent drying time be a period during which an amount of the solvent is eliminated when the solvent is removed through the overlying polyimide film, typically 3 to 30 hours.

The imidization step may be carried out continuous to the solvent removal. As in the conventional methods, imidization may be carried out at an oxygen concentration at which the metal foil, typically copper foil is not oxidized (up to 2% by weight), under reduced pressure or a nitrogen atmosphere, at 250 to 350° C. for 3 to 20 hours. With respect to the form of the laminate assembly which is subject to the lo solvent removal and imidization, the assembly may be in either sheet form or roll form. Moreover, the way of roll winding is not particularly limited in that the metal foil, typically copper foil may be disposed either inside or outside, and even a roll form having a spacer interleaved is acceptable.

In the method of the invention, since the residual solvent after lamination and water (to be removed) after imidization can generate during the solvent removal and imidization steps, heat treatment may preferably be carried out in a loosely wound form or a roll form having a spacer interleaved.

Although the preparation method described above refers to the preparation of a single side metal foil/polyimide laminate, the invention is advantageously applicable to the preparation of a double side metal foil/polyimide laminate. Such a double side metal foil/polyimide laminate is prepared by furnishing a single side laminate having a polyimide film laminated, forming a polyamic acid layer on another metal foil, removing the solvent therefrom to form a coated foil, and bonding the polyamic acid side of the coated foil to the film surface of the single side laminate by means of a heating roll laminator. The laminating conditions and curing (or imidization) conditions may be the same as in the single side laminate preparation method.

### EXAMPLE

Examples and Comparative Examples are given below by way of illustration of the invention although the invention is not limited thereto.

### EXAMPLE 1

Synthesis of Polyamic Acid

218.5 g of pyromellitic anhydride was added to 1 kg of N,N-dimethylacetamide, which was stirred in a N₂ atmosphere and kept at 10° C. 200.5 g of 4,4′-diaminodiphenyl ether in 1 kg of N,N-dimethylacetamide was slowly added thereto such that the internal temperature might not exceed 15° C. Reaction was then conducted at 10-15° C. for 2 hours and continued at room temperature for a further 6 hours. At the end of reaction, a logarithmic viscosity of 0.8 dl/g was measured (using Ubbelohde viscometer at concentration 0.5 g/dl and 30° C.).

Preparation of Laminate

The polyamic acid varnish prepared above was coated onto a 35-μm rolled copper foil cut to 30cm×25 cm to a liquid buildup of 60 μm by means of an applicator and dried in an oven at 120° C. for 5 minutes. The polyamic acid layer had a residual solvent content of 5% by weight, an imidization degree of 3%, and a softening point of 120° C. A 25-μm Apical NPI piece (Kaneka Corp.) cut to 30 cm×25 cm was laid on the coated foil, and the assembly was laminated at 120° C., 15 kg/cm and 4 m/min using a test roll laminator (Nishimura Machinery K.K.). In a N₂ inert oven, it was continuously heat treated at 160° C. for 4 hours, at 250° C. for 1 hour and at 350° C. for one hour. The resulting laminate consisted of a copper foil of 35 μm and a polyimide layer of 30 μm.

Measurement of Residual Solvent Content, Softening Point and Imidization Degree

Measurement was made at the end of drying following application in the process of manufacturing a laminate. The residual solvent content was computed by the formula.
[(weight of coated varnish)−(weight loss after drying)]×100/(weight of coated varnish)

The softening point was measured by scraping the polyamic acid layer after drying, conducting differential scanning calorimetry using DSC-200 (Seiko Electronic Industry Co., Ltd.) and taking a reading on the DSC chart. The imidization degree was computed from the absorbance of imide C=O stretching at 1775 cm⁻¹ relative to the absorbance of benzene ring stretching at 1511 cm⁻¹ in a IR absorption spectrum. Using the sample, peel strength and soldering heat resistance were tested under the following conditions. The results are shown in Table 1.

Peel Strength

According to JIS C6471, the sample having formed a circuit of 1 mm wide was tested by peeling at a pulling speed of 50 mm/min and an angle of 90°.

Soldering Heat Resistance

The sample was immersed in a solder bath at 360° C. for 30 seconds after which it was visually inspected for peeling and blisters.

### COMPARATIVE EXAMPLES 1-3

In Comparative Examples 1 and 2, lamination was done as in Example 1 except that drying was effected so as to form the polyamic acid as shown in Table 1, and peel strength and soldering heat resistance tested. In Comparative Example 3, unlike Example 1, the varnish was applied and dried to the polyimide film, after which it was laminated with a copper foil. The results are shown in Table 1.

TABLE 1

| | | Comparative | | |
|---|---|---|---|---|
| | Example | Example | | |
| Polyamic acid layer after coating and | | | | |
| and drying | | | | |
| Residual solvent content (wt %) | 5 | 1 | 56 | 5 |
| Imidization degree (%) | 2 | 6 | 1 | 3 |
| Softening point (° C.) | 118 | 163 | 57 | 118 |
| Properties after imidization | | | | |
| Peel strength (kg/cm) | 1.1 | 0.5 | 0.3 | 0.4 |
| Soldering heat resistance | OK | OK | NG | OK |
| @ 360° C. × 30s | | | | |

Even in the preparation of all polyimide flexible metal foil/polyimide laminates using heat resistant polyimide adhesive, the inventive method enables such laminates having a thin adhesive layer and featuring an enhanced bond strength to be manufactured at lower drying and laminating temperatures.

1-7. (canceled)

8. A method for preparing a flexible metal foil/polyimide laminate, comprising
laminating a metal foil and a polyimide film, with a heat resistant adhesive comprising a polyamic acid having an imidization degree of less than 5% interleaved therebetween, on a heating roll press, and
then heat treating the laminate for removing the residual solvent from the adhesive layer and heat curing the adhesive layer.

9. The method of claim 8, wherein in the laminating step, the heat resistant adhesive comprises a polyamic acid having a solvent content of 3 to 50% by weight.

10. The method of claim 9, wherein in the laminating step, the heat resistant adhesive having a solvent content of 3 to 50% by weight has a softening point of up to 150° C.

11. The method of claim 8, wherein an adhesive component is a polyamic acid selected from the group consisting of a condensate of pyromellitic anhydride with 4,4′-diaminodiphenyl ether, a condensate of 3,4,3′,4′-biphenyltetracarboxylic anhydride with a p-phenylenediamine, and mixtures thereof.

12. The method of claim 8, wherein the meal foil is a rolled copper foil having a thickness of at least 10 μm, the polyimide film has a thickness of at least 12 μm, and the heat resistant adhesive layer has a thickness of up to 5 μm.

13. The method of claim 8, wherein the flexible metal foil/polyimide laminate is a flexible single side metal foil/polyimide laminate or a flexible double side metal foil/polyimide laminate.
